(19) United States
(12) Patent Application Publication
(10) Pub. No.: US 2010/0196849 A1
(43) Pub. Date: Aug. 5, 2010

(54) FLAPLESS DENTAL IMPLANT PUNCH

(75) Inventors: Ahmed A. Moneim, Los Gatos, CA (US); Dircilene C. Souza, Los Gatos, CA (US)

Correspondence Address: Ahmed A. Moneim, 281 Penn Way, Los Gatos, CA, 95032, US

(73) Assignee: ESYNAPSE CORP., Los Gatos, CA (US)

(21) Appl. No.: 12/763,850

(22) Filed: Apr. 20, 2010

Related U.S. Application Data
(63) Continuation-in-part of application No. 29/329,865, filed on Dec. 22, 2008.

(51) Int. Cl. A61C 3/02

(52) U.S. Cl. 433/144

(57) ABSTRACT

An improved flapless dental implant punch is disclosed. This punch is designed to reduce or eliminate the present cumbersome linear incision method presently used for dental implant procedures. In one embodiment, the invention is a disposable or reusable punch with a handle on one end, and a shank with a roughly cylindrical hollow punch with a circular cutting edge, usually around 1-6 mm in diameter, and often around 2-3 mm in diameter. Unlike prior art punches, however, the invention is configured to additionally make a number of precisely defined linear incisions in the gum tissue during the punching process. As a result, after the underlying jaw bone is exposed by the action of the device, the gum tissue lining the walls of the exposed hole now have enhanced mobility due to the presence of multiple short incisions radiating away from the sides of the gum hole.

### CROSS REFERENCE TO RELATED APPLICATIONS

This application is a continuation in part of, and claims the priority benefit of, U.S. design application 29/329,865, entitled “Dental Flapless X Punch”, Ahmed A. Moneim inventor, filed Dec. 22, 2008; the contents of this application are incorporated herein by reference.

### BACKGROUND OF THE INVENTION

1. Field of the Invention

The invention is in the general field of tools, particularly cutting instruments, for dental implants.

2. Description of the Related Art

Often in dentistry, the tooth is damaged beyond repair, and in order to replace the root of a tooth, a new artificial root must be implanted into the jawbone. To do this, companies, such as Straumann LLC, Andover Mass., a subsidiary of Straumann Holding, Basel Switzerland produce dental implants that can be implanted into the jawbone in a location near where the original tooth root would normally go. These implants essentially look like short screws. The exterior screw thread of the dental implant acts to anchor the implant into the jawbone. One end of the implant has a recess with an interior screw thread. After the implant has been placed into the bone and allowed time for healing and for the nearby bone to regenerate, an abutment device is inserted into the recess, where it can be screwed or locked into place, and this abutment in turn serves as the foundation for the new artificial crown.

In order to insert the dental implant, the dentist must first remove a section of gum tissue in order to get access to the bone. Traditionally, this has been done by first making a linear incision in the gum with a scalpel or other device. The gum (gingival) tissue is then peeled back, exposing the bone. The dentist drills through the bone, making an islet hole. The dentist then inserts the implant, and then closes the gum flap and may suture up the incision with a number of stitches. Unfortunately the method of making larger linear incisions, followed by separating the flap from the bone, can occasionally have adverse consequences to the gum tissue and to the patient.

Although prior art dental tools that can reduce or replace the linear gum incision with a more circular opening are known, exemplified by Yeh et. al., 5,183,053, simply punching a hole in the gum tissue is not widely used because once the gum tissue from the hole has been removed, it is difficult to increase the gum tissue around the implant. Examples of such prior-art punches include the Acu-Punch, manufactured by Acuderm Inc., Fort Lauderdale, Fla.

This need to make incisions, raise the gum tissue flaps, and occasionally harvest gum tissue from a second site also causes various adverse consequences, such as swelling and pain, and increased time to heal, as well as additional time needed for the dentist to perform the gum harvesting procedure. Thus improved methods and tools to manage gum tissue during dental implant procedures would be desirable.

### BRIEF SUMMARY OF THE INVENTION

Here an improved flapless implant punch is disclosed. This flapless implant punch is designed to reduce or eliminate the present cumbersome linear incision, to preserve gum tissue and to augment (increase the thickness) of the gum tissue around the implant without additional procedures.

In one embodiment, the invention is a disposable or reusable punch with a handle on one end, and a shank with a roughly cylindrical hollow punch with a circular cutting edge, usually around 1-6 mm in diameter, and often around 2-3 mm in diameter. Unlike prior art punches, however, the invention is configured to additionally make a number of precisely defined limited linear incisions in the gum tissue during the punching process. As a result, after the underlying jaw bone is exposed by the action of the device, the gum tissue lining the walls of the exposed hole now have enhanced mobility due to the presence of multiple short incisions radiating away from the sides of the gum hole. This increased mobility can be used to enhance the gum tissue around the implant. Once the gum tissue has been cut, the instrument can also be used to reposition or “reflect” the gum tissue to a desired location.

The increased gum tissue mobility brought about by the use of the flapless implant punch can be utilized in a number of ways. In one aspect, it now becomes possible to perform a dental implant by a minimally invasive process in which the flapless implant punch is used to punch a very small diameter hole in the gum tissue. The series of small linear incisions on the gum tissue lining this small diameter hole act to mobilize the gum tissue enough so that once the dental implant is placed, the hole can be sealed by the implant itself, either by a small suture or without a suture.

Alternatively, when the implant is placed, and then other artificial tooth components are placed, the series of small linear incisions on the gum tissue lining the small diameter hole mobilizes the gum tissue, and allows the gum tissue to first expand as the new artificial tooth is implanted, and then relax back surrounding the new artificial tooth with a small mound of gum tissue. Again, the flapless implant punch allows this alternative implant procedure to operate without the need to make a large linear incision in the gum tissue, and without the need to harvest additional gum tissue from elsewhere in the mouth.

Various alternative embodiments of this flapless implant punch will be described in more detail in the following sections.

### BRIEF DESCRIPTION OF THE DRAWINGS

FIG. 1 shows an overview of a linear, four bladed version of the flapless implant punch.

FIG. 2 shows an overview of a bent (non-linear) four bladed version of the flapless implant punch.

FIG. 3 shows three alternative blade configurations of the flapless implant punch, in which the blades are mounted flush with the circular cutting surface of the punch's cylindrical body.

FIG. 4 shows an alternative embodiment the three alternative blade configurations are mounted recessed from the circular cutting surface of the punch's cylindrical body.

FIG. 5 shows six alternative embodiments of the flapless implant punch with four blades, three blades, two blades and one blade mounted at a 90 degree angle with respect to each other. An additional configuration in which three blades are mounted at a 120 degree angle with respect to each other is also shown.

FIG. 6 shows a drawing of how the flapless implant punch may operate in both punching a small diameter hole through gum tissue, and creating mobilized gum tissue on the sides of the small diameter hole which may then be utilized to either subsequently re-suture the hole shut (not shown) or alternatively be utilized to build a small ridge of gum tissue around an implanted artificial tooth.

### DETAILED DESCRIPTION OF THE INVENTION

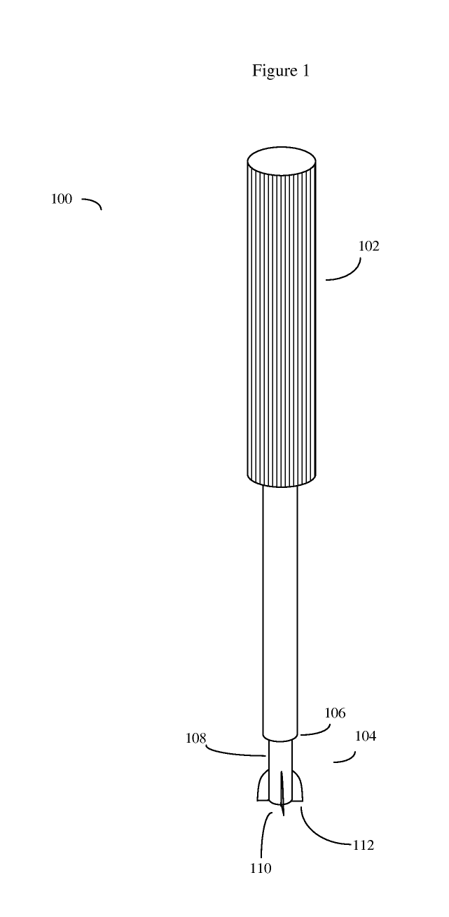

FIG. 1 shows a drawing of one embodiment of the invention. The invention is a disposable or reusable dental instrument (100), which as previously discussed may be used for various purposes, including removing a plug of gum tissue from a dental patient's jaw. The invention is particularly useful for exposing small sections of the jaw bone underneath the gum tissue, which is often required for dental implant surgery. The instrument has an elongated handle member (102). This handle member (102) is configured to retain a smaller and thinner cutting member (104). The handle (102) is often made of plastic, while the cutting member (104) is often made out of surgical steel, stainless steel or other material, often a metal, which can hold a cutting edge. The cutting member (104) can be held or retained on the handle (102) by a wide variety of different means including press-fitting or other methods. In some embodiments, the handle itself may be metal, durable plastic, or other material that can itself maintain a cutting edge, in which case the entire instrument (100) may be formed from a single piece of the same material. In the particular embodiment shown in FIG. 1, a press-fit retention joint region (106) is shown.

The cutting member shank (104) will typically have a substantially cylindrical hollow body (108) that is retained by the handle (102). The extreme distal portion of the cylinder (110) typically has a sharpened edge. A number (typically 1-6, and often 2-4) of different cutting blades (112) that create short linear incisions (and are thus termed linear cutting blades) extend outward from the circumference of cylinder (108). As a result, the combination of the circular cutting edge of cylinder (110) and the short linear incisions formed by the blades (112) will create a cutting pattern that looks much like a circle with rays extending from the circle, and this cutting pattern will be termed a rayed circular pattern, and the combination of the cutting circle and the linear blades will be termed a rayed-circular cutting surface.

As previously discussed, typically the interior of the cylinder (cylindrical body) (108) is hollow. The total depth of the cylinder will vary, but will usually be at least 5 mm deep. Ideally the depth should be deep enough to at least accommodate the thickness between the surface of the gum tissue, and the underlying bone.

The diameter of the cylindrical body (108) will vary depending upon the patient and the amount of accessible area on the jaw. Larger diameters will expose more bone surface and make it easier to place an implant, but limitations on available space on the jaw, as well as the greater amount of trauma caused by cutting a larger region the gum tissue, tend to place an upper limit on the diameter of the cylinder. On the other end of the diameter range, if the diameter becomes too narrow, an insufficient region of the jaw bone will be exposed, making it difficult to place an implant. The optimum diameter for the cylindrical body is thus a compromise, and will typically be between 1 and 6 mm, and will often be between 2-4 mm in diameter.

Similarly, the length of the incision created by the various linear cutting blades is also a compromise. One important purpose of the incisions is to partially mobilize gum tissue in the region around the circular hole formed by the cutting edge of the cylindrical body (110). That is, the gum tissue in-between the various linear incisions are more able to move or be repositioned. The longer the incision, the greater the amount of gum tissue that can be repositioned, but again as the linear cutting blade length increases, the chances that the blade will encounter an obstruction will also increase. Longer lengths again create more trauma to the gum as well.

The number of linear cutting blades (112) also represents a tradeoff. More cutting blades will partition the gum tissue into smaller and smaller regions, which will increase gum tissue mobility, but will also have negative consequences such as cutting off blood supply to the cut sections of gum, increasing the chance that the cut gum tissue will die, rather than heal properly. Thus the number of linear cutting blades (112), and the length of the linear cutting blades is thus also a series of compromises. Often the incision or cut formed by each cutting blade (112), which is a direct reflection of the length of the linear cutting blades, is approximately 1 to 6 mm, and will often be in the range of 2-3 mm. The number of cutting blades (112) will typically range from 1 to 4 blades, and often 4 blades will be used. These will usually, but not always, be arranged at a separation angle of between 60 to 180 degrees from each other, and often at around 90 degrees from each other.

It should be apparent that when the distal region (110), (112) of the instrument (100) is pressed onto the surface of the gum tissue of a jaw, the instrument will produce a circular incision with a plurality of ray incisions extending outward from the circumference of the circular incision.

It is important to recognize that the instrument is intended to be used by a working dentist to work on various regions of the jaw of a human patient. The patient must open their mouth, and the regions of the jaw nearer the front of the mouth will be more accessible than the regions near the back of the mouth. Particularly for regions near the back of the mouth, the instrument will often need to be bent, rather than straight, in order to both fit into the mouth, and then be manipulated by the dentist to produce the appropriate cutting results.

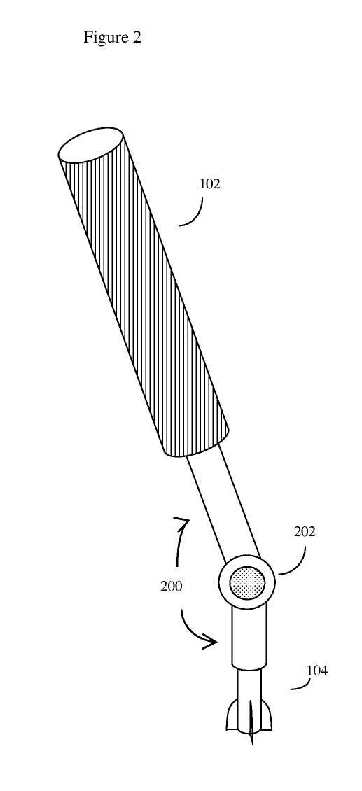

To do this, the handle may be bent, or made of a malleable (bendable) material, or incorporate a cam-operated or click-stop swivel joint or rotary joint, and this bent handle configuration is shown in FIG. 2. Here the angle (200) between the handle (102) and the cutting member shank (104) can vary from a straight 180 degree configuration to as much as a right angle 90 degree orientation. In FIG. 2, an approximate angle of about 165 degrees is shown, here with a click-stop rotary joint (202). The number of different click-stops and the angles may vary, but often click-stops that operate at the 90 degree and 180 degree (straight) angles may be used.

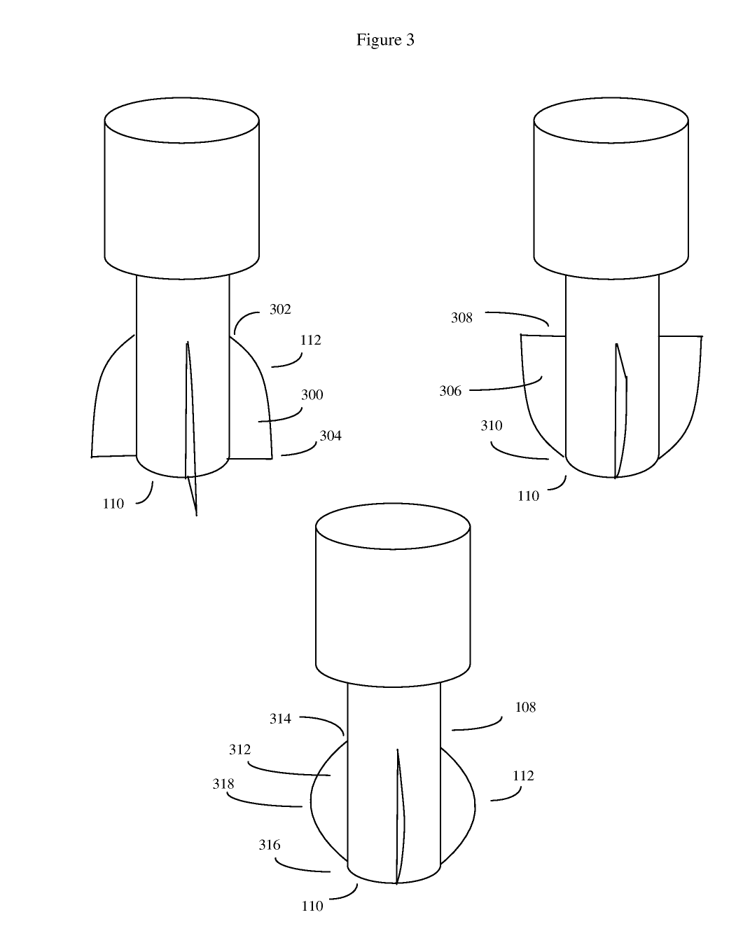

A number of different types of linear cutting blades may be used, and these blades may be arranged in different configurations. Some examples of suitable blade configurations or embodiments are shown in FIG. 3.

In FIG. 3 shows an embodiment in which the cutting surfaces of the various cutting blades generally start or commence flush with the cutting end (110) of cylinder (108), so that when the instrument is initially pressed into gum tissue, the circular cutting surface (110) and the linear cutting surface (blades) (112) commence cutting simultaneously. In one embodiment (300), the linear cutting blades (112) (300) have a generally quarter circular configuration that begins (302) flush with said cylindrical body at a first portion distal from said circular cutting surface (110), and ends abruptly jutting out from said cylindrical body at a second position proximal (304) to said circular cutting surface (110).

In an alternative embodiment, the linear cutting blades (112) (306) have a generally quarter circular configuration that abruptly juts out from said cylindrical body at a first position distal from said circular cutting surface (308), and ends flush with said cylindrical body at a second position proximal (310) to said circular cutting surface (110).

In another embodiment, the linear cutting blades (112), (312) have a generally crescent shaped configuration that begins flush with said cylindrical body at a first position distal from said circular cutting surface (314), ends flush with said cylindrical body at a second position proximal to said circular cutting surface (316), and projects outward from said cylindrical body midway (318) between said first position and said second position.

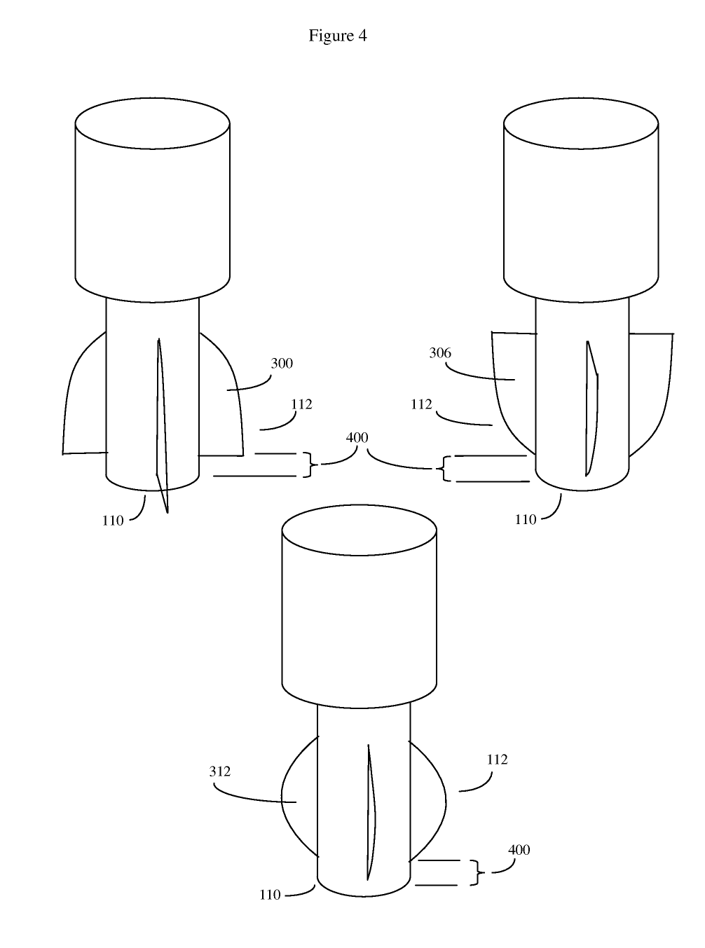

In order to reduce the pressure needed to cut the gum tissue, and also to help insure that the instrument is firmly in place before commencing the linear cuts, often it may be useful to recess the linear cutting blades from the circular cutting surface (110) by a small distance, such as 0.5 to 2 mm, and often about 1 mm. This embodiment is shown in FIG. 4. Here, the cutting surfaces of the linear cutting blades (112) (300), (306), (312) are located a distance (400) of between 1 and 2 mm behind the circular cutting surface (110), so that when the instrument (100) is initially pressed into gum tissue, the circular cutting surface (110) commences cutting before the linear cutting blades (112), (300), (306), (312) commence cutting. This recessed configuration is also useful for situations when the dentist wishes to use the instrument to only make a circular cut.

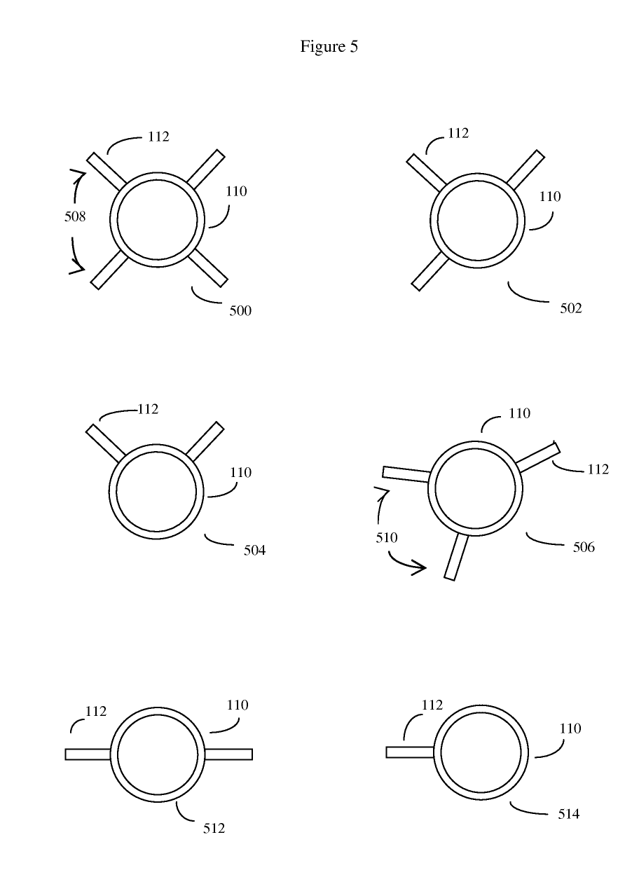

FIG. 5 shows the cutting surfaces of the circular cutting surface (110) and linear cutting blades (112). This also shows the cuts that various embodiments of the instrument (100) may make into gum tissue, as well as various alternative blade arrangements. In (500), a four bladed arrangement with a 90 degree angle (508) between the blades is shown. In (502), a three bladed arrangement, still with a 90 degree angle between the blades is shown. Often such asymmetrical blade arrangements may be needed because only gum tissue on one side of the jaw or a portion of the jaw may need to be mobilized and reconfigured. In (504) a two bladed arrangement, still with a 90 degree angle between the blades is shown. In (506), an alternative three bladed arrangement, this time with a 60 degree angle between two blades (510), and a 150 degree angle between the other blades is shown. In (512), an alternative two bladed arrangement with a 180 degree angle between the blades is shown. In (514), an alternative one blade arrangement is shown.

In some embodiments, it may be useful to make the cutting shank (104) demountable or removable from the handle (102). For example, a kit containing a variety of different cutting shanks (i.e. 1, 2, 3, 4 bladed versions, recessed and non-recessed versions) provided with a common handle (102) may be provided, and the dentist may pick which cutting shank is most appropriate to the particular implant region, and mount the cutting shank onto the handle prior to use. This mounting could be done, for example, by a screw joint, (106) snap-to fit joint (106), or other joint that enables the shank to be joined to the handle without an undue amount of effort. Here ideally a hand operated connection mechanism is preferred. Alternatively the linear cutting blades themselves may be capable of being mountable or demountable from the cutting shank.

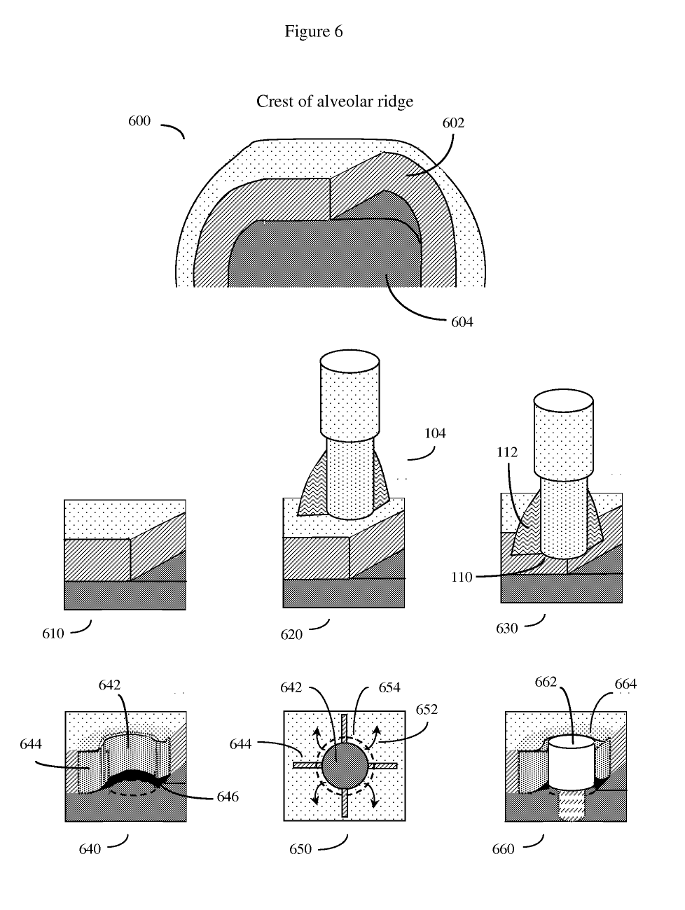

FIG. 6 shows an example of the instrument in operation. Here the curved surface of a portion of the jaw (the crest of alveolar ridge) is shown in partial cut-away (600); exposing a corner of gum tissue (602) and the underlying bone (604). The operation of instrument (100) during an implant procedure is also shown. (610) shows a small section of the gum and bone from the top of the jaw line. Assume that this is the site on the jaw where the dentist wishes to place an implant. In (620), the dentist is about to make a hole in the gum tissue with the cutting member shank (104) of the device. In (630), the dentist has started to press the device into the gum tissue. The circular cutting surface of the cylinder (110) is pressing into the gum tissue and cutting a hole. At the same time, the linear cutting blades (112) are making small incisions into the gum, which can act to mobilize the gum tissue local to the circular incision. In 640, the dentist has removed the tool leaving a circular hole (642) (shown in partial cross section) and some linear incisions (644). Due to the linear incisions, the gum tissue in this region is partially mobilized and can change position, as is indicated by the dark region (showing partial gum separation from the bone) (646).

By contrast, (650) shows an alternate dentist's eye view looking down on the surface of the gum, the circular hole, and four incisions from above. The gum tissue between the flaps can be repositioned, “reflected”, or peeled back (652), often by use of periosteal elevators, to accommodate a dental implant or artificial crown that has a diameter (654) somewhat larger than that of the diameter of the circular hole (642).

In 660, the dentist has inserted an implant into the bone and an abutment has been attached (662). Because the gum tissue has been partially mobilized, it can deform somewhat and ride up on the surface of the abutment, forming a better seal (664), as well as a better (more aesthetic looking) appearance of the gum tissue. Alternatively, the mobilized gum tissue is easier to stretch and use to suture the hole shut (not shown).

### ADVANTAGES OF THIS APPROACH

The instrument helps preserve gum tissue, and enhances the appearance of the gum tissue around the dental implant. In particular, the method reduces the likely hood that an aesthetically displeasing “black triangle” space or gap may form between the implant and the adjacent tooth or other implant. An additional advantage of this approach is that it reduces the need to obtain a second source of gum tissue (from elsewhere in the mouth) to build up the thickness of the gum in the implant region. Other advantages of the instrument include:

1: It can be used in a minimally invasive procedure where a much smaller amount of gum tissue needs to be cut.
2: It preserves existing gum tissue that otherwise might be damaged by conventional linear-incision and separation from bone techniques.
3: It preserves blood circulation in the gum tissue around the implant.
4: It reduces the chances that the gum tissue will subsequently recede.
5: It reduces or eliminates the need for further gum augmentation.
6: It allows a one step process and surgery.
7: It reduces (or eliminates) the need for sutures.
8: As previously discussed, it reduces the rate of occurrence of the “black triangle between the teeth” problem.
9: It reduces the length of time required for the implant operation.

1. A dental instrument for removing and/or reflecting gum tissue from a jaw, thereby exposing underlying bone for dental implant purposes, comprising:
an elongated handle member configured to retain a cutting member shank formed integrally on one end of said handle member;
said cutting member shank comprising a substantially cylindrical body retained by said elongated handle member and projecting therefrom to expose, on the distal end of said substantially cylindrical body, a rayed-circular cutting surface;
said rayed circular cutting surface comprising a circular cutting surface with at least one linear cutting blade(s) extending outward from the circumference of said substantially cylindrical body;
wherein the interior of said substantially cylindrical body is hollow and at least 5 mm deep;
wherein the diameter of said circular cutting surface is between 1 and 6 mm;
and wherein the length each of said at least one linear cutting blades is between 1 and 5 mm; and
wherein when said instrument is pressed into the surface of the gum tissue of a jaw, said instrument produces a circular incision with at least one ray incision(s) extending outward from the circumference of said circular incision.

2. The instrument of claim 1, wherein said at least one linear cutting blades are between 1 and 6 blades inclusive, and in which the angle between each of said linear cutting blades as said linear cutting blades are disposed outward from the circumference of said circular cutting surface is between 60 and 180 degrees.

3. The instrument of claim 1, wherein the cutting surfaces of said at least one linear cutting blades are flush with said circular cutting surface, so that when said instrument is initially pressed into said gum tissue, said circular cutting surface and said linear cutting blades commence cutting simultaneously.

4. The instrument of claim 1, wherein the cutting surfaces of said at least one linear cutting blades are located between 0.5 and 2 mm behind said circular cutting surface, so that when said instrument is initially pressed into said gum tissue, said circular cutting surface commences cutting before said at least one linear cutting blades commence cutting.

5. The instrument of claim 1, wherein said linear cutting blades have a generally crescent shaped configuration that begins flush with said cylindrical body at a first position distal from said circular cutting surface, ends flush with said cylindrical body at a second position proximal to said circular cutting surface, and projects outward from said cylindrical body midway between said first position and said second position.

6. The instrument of claim 1, wherein said circular cutting surface is on the end of a cylindrical body that is mounted on one end of said handle member, and wherein said linear cutting blades have a generally quarter circular configuration that abruptly juts out from said cylindrical body at a first position distal from said circular cutting surface, and ends flush with said cylindrical body at a second position proximal to said circular cutting surface.

7. The instrument of claim 1, wherein said circular cutting surface is on the end of a cylindrical body that is mounted on one end of said handle member, and wherein said linear cutting blades have a generally quarter circular configuration that begins flush with said cylindrical body at a first portion distal from said circular cutting surface, and ends abruptly jutting out from said cylindrical body at a second position proximal to said circular cutting surface.

8. The instrument of claim 1, in which said elongated handle member is bent at an angle between 90 and 180 degrees.

9. The instrument of claim 1, in which said elongated handle member contains a bendable joint or malleable region between said handle member and said cutting member that enables said cutting member to be disposed at an angle of between 90 and 180 degrees from said handle member.

10. The instrument of claim 1, in which said elongated handle member contains a click-stop swivel joint between said handle member and said cutting member that enables said cutting member to be disposed at an angle of between 90 and 180 degrees from said handle member.

11. The instrument of claim 1, wherein said cutting member shank and said linear cutting blades are made from materials selected from the group consisting of surgical steel, stainless steel, and other cutting material.

12. The instrument of claim 1, wherein said elongated handle member is made from plastic or a reusable metal.

13. The instrument of claim 1, wherein said cutting member shank may be detached and then remounted on said elongated handle member, or said linear blades may be detached and then remounted on said cutting member shank.

14. A dental instrument for removing and/or reflecting gum tissue from a jaw, thereby exposing underlying bone for dental implant purposes, comprising:
an elongated handle member configured to retain a cutting member shank formed integrally on one end of said handle member;
said cutting member shank comprising a substantially cylindrical body retained by said elongated handle member and projecting therefrom to expose, on the distal end of said substantially cylindrical body, a rayed-circular cutting surface;
said rayed circular cutting surface comprising a circular cutting surface with a plurality of linear cutting blades extending outward from the circumference of said substantially cylindrical body;
wherein said plurality of linear cutting blades are between 2 and 4 blades inclusive, and in which the angle between each of said linear cutting blades as said linear cutting blades are disposed outward from the circumference of said circular cutting surface is between 60 and 180 degrees;
wherein the interior of said substantially cylindrical body is hollow and at least 5 mm deep;
wherein the diameter of said circular cutting surface is between 1 and 6 mm;
and wherein the length each of said plurality of linear cutting blades is between 1 and 5 mm; and
wherein when said instrument is pressed into the surface of the gum tissue of a jaw, said instrument produces a circular incision with a plurality of ray incisions extending outward from the circumference of said circular incision.

15. The instrument of claim 14, wherein said plurality of linear cutting blades is four blades, and wherein which said angle between each of said linear cutting blades as said linear cutting blades are disposed outward from the circumference of said circular cutting surface is 90 degrees.

16. The instrument of claim 14, in which said elongated handle member contains a bendable joint or malleable region or click-stop swivel joint between said handle member and said cutting member that enables said cutting member to be disposed at an angle of between 90 and 180 degrees from said handle member.

17. The instrument of claim 14, wherein the cutting surfaces of said plurality of linear cutting blades are located between 0.5 and 2 mm behind said circular cutting surface, so that when said instrument is initially pressed into said gum tissue, said circular cutting surface commences cutting before said plurality of linear cutting blades commence cutting.

18. The instrument of claim 14, wherein the instrument also increases the gum tissue around the implant.

19. A dental instrument for removing and/or reflecting gum tissue from a jaw, thereby exposing underlying bone for dental implant purposes, comprising:
an elongated handle member configured to retain a cutting member shank formed integrally on one end of said handle member;
said cutting member shank comprising a substantially cylindrical body retained by said elongated handle member and projecting therefrom to expose, on the distal end of said substantially cylindrical body, a rayed-circular cutting surface;
said rayed circular cutting surface comprising a circular cutting surface with a plurality of linear cutting blades extending outward from the circumference of said substantially cylindrical body;
wherein said plurality of linear cutting blades is four blades, and in which the angle between each of said linear cutting blades as said linear cutting blades are disposed outward from the circumference of said circular cutting surface is 90 degrees;
wherein the interior of said substantially cylindrical body is hollow and at least 5 mm deep;
wherein the diameter of said circular cutting surface is between 1 and 6 mm;
and wherein the length each of said plurality of linear cutting blades is between 1 and 5 mm;
wherein when said instrument is pressed into the surface of the gum tissue of a jaw, said instrument produces a circular incision with a plurality of ray incisions extending outward from the circumference of said circular incision; and
in which said elongated handle member contains a bendable joint or malleable region, or click-stop swivel joint between said handle member and said cutting member that enables said cutting member to be disposed at an angle of between 90 and 180 degrees from said handle member.

20. The instrument of claim 19, wherein the cutting surfaces of said plurality of linear cutting blades are located between 0.5 and 2 mm behind said circular cutting surface, so that when said instrument is initially pressed into said gum tissue, said circular cutting surface commences cutting before said plurality of linear cutting blades commence cutting.
